(19) United States
(12) Patent Application Publication
(10) Pub. No.: US 2009/0028983 A1
(43) Pub. Date: Jan. 29, 2009

(54) Injection mold with a tie bar

(76) Inventors: Chih-Yu Chen, Tu-Cheng City (TW); Jian-Guang Huang, Tu-Cheng City (TW); Yun-Ging He, Tu-Cheng City (TW); Chun-Yan Wu, Tu-Cheng City (TW); Luan-Guang Li, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,182

(22) Filed: Jul. 23, 2007

(51) Int. Cl. B29C 45/64

(52) U.S. Cl. 425/542

(57) ABSTRACT

The injection mold with a tie bar includes an upper stationary board, a stripping plate, a female board, a male board and a lower stationary plate from top to bottom. The upper stationary plate extends outward to form a projection plate, an accepting hole opened in the projection plate and having a step therein. A tie bar is arranged on the outside of the injection mold and includes a stud, a connecting head and a pole. The stud passes through the accepting hole and is fixed on the top of the pole. The stud is slidable along the accepting hole and against the step. The top of the pole is located the outside of the stripping plate while the bottom extends outward to form at least one block. The connecting head has a gap for encircling the pole and is slidable along the pole and against the block of the pole.

### BACKGROUND OF THE INVENTION

1. Field of the Invention

This present invention relates to an injection mold, and in particular to an injection mold with a tie bar.

2. The Related Art

Conventionally, in a traditional three-plate mold, a tie bar included in the traditional three-plate mold is used to limit the distance of an upper fixed plate, a stripping plate and a female board while the traditional three-plate mold is opened, so the plastic end is automatically separated from a product formed in the traditional three-plate mold while the three-plate mold is opened. The traditional tie bar includes a contour screw and a bar, which are assembled in the corners of the traditional tie bar. The contour screw passes through the upper fixed plate and connects the bar. The bar includes a bar head and a bar body. The bar head is fixed in the stripping plate, the bar body passes through the female board and extends into a male board.

Because the tie bar is located in the three-plate injecting mold, the volume of the mold must be large to arrange the tie bar, and some cavities must be finished in the male injecting mold for the tie bar being accepted in the male injecting mold when the three-plate injecting mold is closed. As the above description, the three-plate injecting mold is difficulty to be manufactured for the cavities in the male injecting mold, and the volume of the three-plate injecting mold is large for arranging the tie bar in the three-plate injecting mold.

### SUMMARY OF THE INVENTION

An object of the present invention comprises an injection mold with a tie bar. The injection mold with a tie bar includes an upper stationary board, a stripping plate located below the upper stationary plate, a female board located below the stripping plate, a male board located below the female board, and a lower stationary plate located below the male board. The upper stationary plate extends outward to form a projection plate. An accepting hole is opened in the projection plate from top to bottom, the accepting hole has an upper part and a lower part less than the upper part to form a step therebetween. A tie bar is arranged on the outside of the injection mold. The tie bar includes a stud, a connecting head and a pole. The stud passes through the accepting hole and is fixed to the top of the pole, the stud can slide along the accepting hole and be against the step of the accepting hole. The top of the pole is fixed on the outside of the stripping plate, the bottom of the pole extends outward to form at least one block. The connecting head is fixed on the outside of the female board. The connecting head has a gap for encircling the pole, the pole can slide along the pole and be against the block of the pole.

As above description, the tie bar arranged on the outside of the injection mold can control the distance between the upper stationary plate, the stripping plate and the female board while the injection mold is opened. So a plastic end can be cut automatically by the present invention, and the inner space of the injection mold increases, the injection mold is easy to manufacture.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of an injection mold with a tie bar according to the present invention;

FIG. 2 is an exploded perspective view of the injection mold with a tie bar;

FIG. 3 is a perspective view of a tie bar of the injection mold with a tie bar;

FIG. 4 is an exploded perspective view of the tie bar;

FIG. 5 is a side view of the tie bar; and

FIG. 6 is a side view of the injection mold with a tie bar.

### DETAILED DESCRIPTION OF THE PREFERRED EMBODIMENT

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

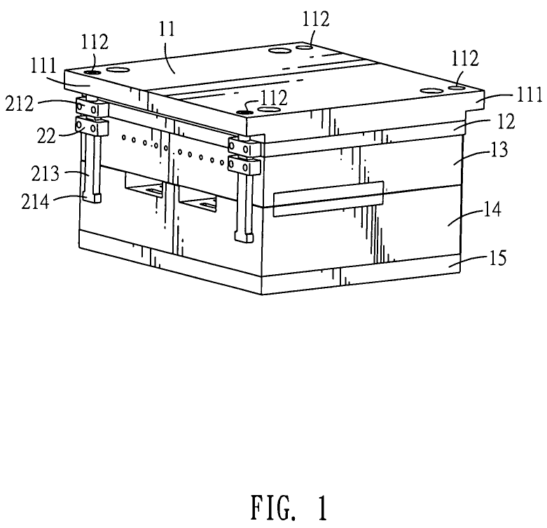

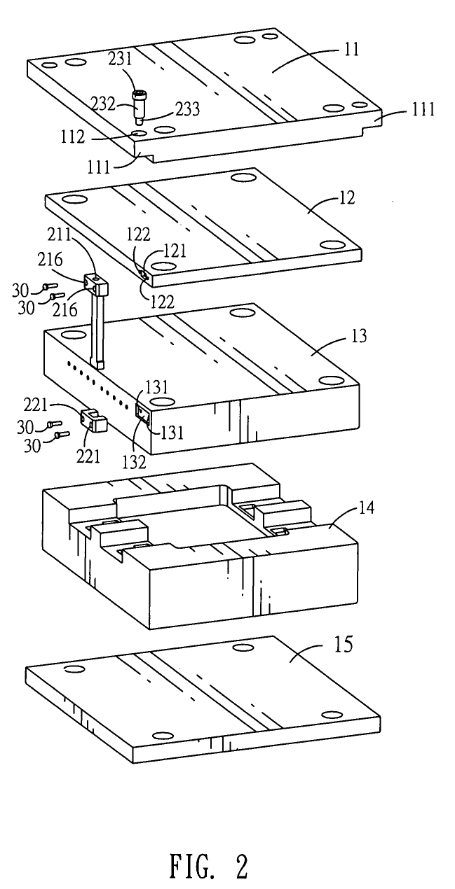

First referring to FIG. 1, an injection mold with a tie bar 1 according to the invention is shown. The injection mold with a tie bar 1 comprises an upper stationary plate 11, a stripping plate 12 located below the upper stationary plate 11, a female board 13 located below the stripping plate 12, a male board 14 located below the female board 13, a lower stationary plate 15 located below the male board 14 and four tie bars 20. The tie bar 20 is fixed on the outside of the injection mold 1.

The two sides of the upper stationary plate 11 extend horizontally to form two projection plates 111. Two accepting holes 112 are opened in two ends of the projection plate 111 from top to bottom. The diameter of an upper part of the accepting hole 112 is larger than the diameter of a lower part of the accepting hole 112 to form a step. Two grooves 121 are opened in two ends of the outside of the stripping plate 12. Two first screw cavities 122 are opened in two sides of the groove 121. Two accepting flute 132 are opened in two ends of the outside of the female board 13, two second screw cavities 131 are opened in two sides of the bottom of the accepting flute 132.

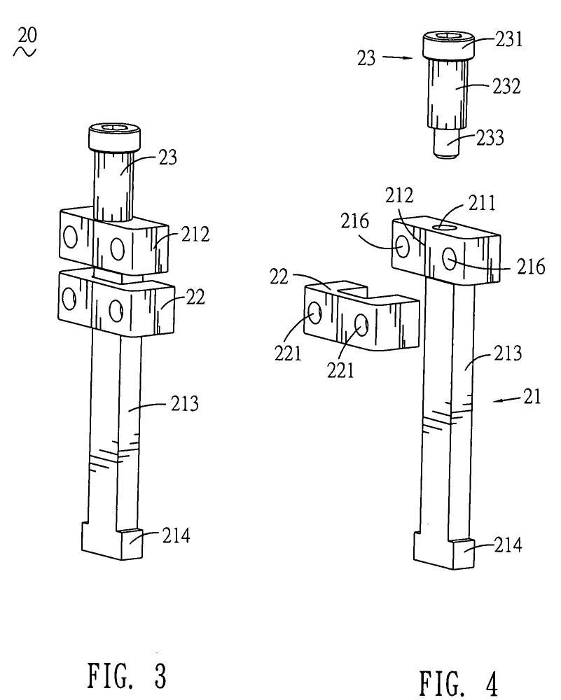

Please refer to FIGS. 3, 4 and 5, the tie bar 20 includes a pole 21, a connecting head 22 and a stud 23. The stud 23 includes a nut 231, a shank 232 and a locking bar 233 from top to bottom. The diameter of the nut 231 is more than the diameter of the shank 232, and the diameter of the shank 232 is more than the diameter of the locking bar 233. The diameter of the nut 231 is less than the diameter of the upper part of the accepting hole 112, and more than the diameter of the lower part of the accepting hole 112. The diameter of the shank 232 is less than the diameter of the lower part of he accepting hole 112. So the stud 23 can be accepted in the accepting hole 112 and cannot drop from the accepting hole 112. The locking bar 233 can downward pass through the accepting hole 112 and connects the pole 21.

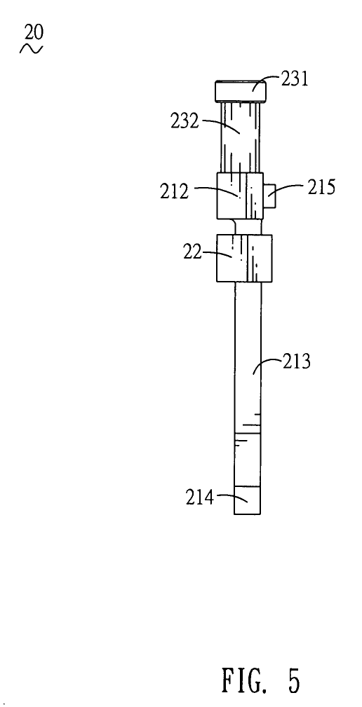

The pole 21 has a pole head 212 showing a cube shape. A screw hole 211 is opened in the top surface of the pole head 212 for fixing the locking bar 233 therein, so the pole 21 and the stud 23 are fixed together. A locking lump 215 projects from one side of the pole head 212 toward the stripping plate 12 (as shown in FIG. 5). The locking lump 215 is inserted into the groove 121 opened in the outside of the stripping plate 12. Two third screw cavities 216 are opened in the pole head 212 and locate at the two sides of the locking lump 215. Two screws pass through the third screw cavities 216 to fix the pole head 212 on the outside of the stripping plate 12. The bottom surface of the pole head 212 extends downward to form a bar body 213 showing a rectangular solid shape. Two blocks 214 are arranged in the end of the bar body 213. The blocks 214 are used to limit the activity scope of the connecting head 22 along the bar body 213.

The connecting head 22 shows a U-shape, so a gap is formed between the connecting head 22 and the female board 13. Two fourth screw cavities 221 are opened in the two sides of the connecting head 22. The connecting head 22 covers the bar body 213 through the gap, and a part of the connecting head 22 is accepted in the accepting flute 132, two screws 30 pass through the fourth screw cavities 221 and the second screw cavities 131 to fix the connecting head 22 on the out side of the female board 13, so the bar body 213 can move along the gap.

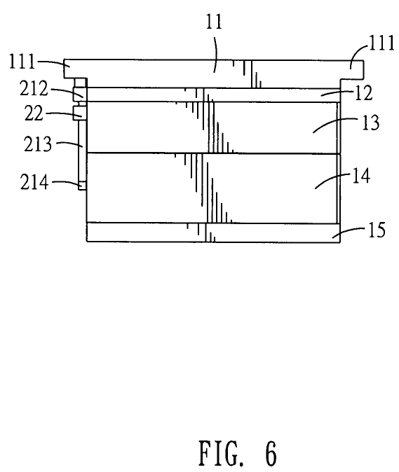

Referring to FIG. 6, in this embodiment, the tie bars 20 are arranged in the two ends of the two sides of the injection mold. And the tie bars 20 can be arranged in anywhere of the outsides of the injection mold. The amount of the tie bars 20 is not limited to four, the amount can be changed according to the need of the injection mold. So the amount and the location of the accepting holes 112 can be changed according to the tie bars 20.

When the injection mold with tie bar 1 is opened, the lower stationary plate 15 drags downward the male mold 14 and the female mold 13, fixed together by a puller (not shown), and the female mold 13 separates with the stripping plate 12, the plastic end is cut off. The female mold 13 moves downward further, the connecting head 22 fixed in the outside of the female board 13 moves along the bar body 213 toward the block 214, in the end, the connecting head 22 is against the block 213, then the stripping plate 12 is drew to separate with the upper stationary plate 11. When the nut 231 of the stud 23 is against the step of the accepting hole 112, the stripping plate 12 and the female board 13 stop action, the male mold 14 moves downward continually, in the end, the puller cannot sustain the strength from the male mold 14, the male mold 14 and the female board 13 are separated, a thimble (not shown) pushes a product from the injection mold 1. Thereby, the opening motion of the injection mold 1 is finished.

As above description, the pole head 212 of the tie bar 20 is fixed on the outside of the stripping plate 12, the stud 23 is accepted in the upper stationary plate 11, the connecting head 22 is fixed in the outside of the female mold 13, the block 214 is formed in the end of the bar body 213 to limit the motion distance of the connecting head 22 moving along the bar body 213. So the distances between the upper stationary plate 11 and the stripping plate 12 and between the stripping plate 12 and the female board 13 are limit, and the male mold 14 is not need to be manufactured like a traditional male mold of a traditional injection mold. The cost of the manufacture of the injection mold with a tie bar reduces, the inner room of the injection mold increases, and the injection mold is easy to be manufactured.

What is claimed is:

1. An injection mold with a tie bar, comprising:
an upper stationary plate, the upper stationary plate extending outward to form a projection plate, an accepting hole opened in the projection plate from top to bottom, the accepting hole having an upper part and a lower part to form a step therebetween;
a stripping plate, located below the upper stationary plate;
a female board, located below the stripping plate;
a male board, located below the female board;
a lower stationary plate, located below the male board; and
a tie bar, arranged on the outside of the injection mold, the tie bar including
a pole, the top of the pole fixed on the outside of striping plate, the bottom of the pole extending outward to form a block,
a stud, passing through the accepting hole and fixed to the top of the pole, the stud being slidable along the accepting hole and able to against the step of the accepting hole, and
a connecting head, mounted on the female board, for encircling the pole and making the female board slidable over the pole and further being limited by the block.

2. The injection mold with a tie bar as set forth in claim 1, wherein the stud includes a nut, a shank less than the nut and a locking bar less than the shank from top to bottom, the nut being able to against the step of the accepting hole, the locking bar is fixed to the top of the pole.

3. The injection mold with a tie bar as set forth in claim 1, wherein the top of the pole has a pole head fixed on the outside of the stripping plate and connecting the stud, the pole head protrudes outward to form a locking lump inserted into a groove opened in the outside of the stripping plate.

4. The injection mold with a tie bar as set forth in claim 1, wherein the connecting head shows a U-shape.

5. The injection mold with a tie bar as set forth in claim 4, wherein the outside of the female board defines an accepting flute, a part of the connecting head fixed in the accepting flute.

6. The injection mold with a tie bar as set forth in claim 1, wherein the injection mold includes four said tie bars fixed to two ends of two opposite sides thereat.
